(19) United States
(12) Patent Application Publication
(10) Pub. No.: US 2021/0078082 A1
(43) Pub. Date: Mar. 18, 2021

(54) CLAMPING DEVICE

(71) Applicant: SMW-Autoblok Spannsysteme GmbH, Meckenbeuren (DE)

(72) Inventor: Eckhard Maurer, Oberteuringen (DE)

(21) Appl. No.: 17/017,957

(22) Filed: Sep. 11, 2020

(30) Foreign Application Priority Data
Sep. 12, 2019 (EP) 19 196 889.0

(51) Int. Cl. B23B 31/20

(52) U.S. Cl. CPC B23B 31/207

(57) ABSTRACT

In a clamping device (1) for the centred and repetitively accurate support of an object (2), in particular a workpiece to be machined on a machine tool, a tool or the like, the clamping device comprising:
a chuck body (3) in which a receiving opening (4) is incorporated which has a longitudinal axis (5) as a centring reference for the object (2),
a pulling element (6) which is mounted axially movably in the receiving opening (4),
a collet chuck (7) which is inserted into the receiving opening (4) centred on the longitudinal axis (5) of the receiving opening (4) and which is driveably coupled to the pulling element (6), and
a conical centring surface (8) which is worked onto the inner wall in the entrance area of the receiving opening (4),
   it should be possible to insert a large number of objects (2) of different sizes into a receiving opening (4) of a chuck body (3) and locked in a centred position in this opening without the chuck bodies (3) or their receiving openings (4) having to be adapted to the differently sized collet chucks (7).

This is achieved in that an adapter sleeve (11) is provided, which is arranged between the receiving opening (4) of the chuck body (3) and the collet chuck (7) in the mounted condition, positionally oriented and centred on the conical centring surface (8), in that the outer contour of the adapter sleeve (11) is adapted to the inner contour of the receiving opening (4), in that the collet chuck (7) is mounted in the adapter sleeve (11) so as to be axially movable, and in that the inner contour of the adapter sleeve (11) has an inwardly inclined contact surface (12) which interacts with the outer contour of the collet chuck (7) in such a way that the inner diameter of the collet chuck (7) is reduced when the collet chuck (7) is drawn into the chuck body (3) by the pulling element (6), and the object (2) is thereby held centred and positionally oriented by the collet chuck (7).

### REFERENCE TO PENDING PRIOR PATENT APPLICATION

This patent application claims benefit of European Patent Application No. 19 196 889.0, filed Sep. 12, 2019, which patent application is hereby incorporated herein by reference.

### FIELD OF THE INVENTION

The present invention relates to a clamping device for the centred and repetitively accurate support of an object, in particular a workpiece to be machined on a machine tool, tool or the like, according to the pre-characterising clause of Patent Claim 1.

### BACKGROUND OF THE INVENTION

Clamping devices have been used for decades to hold workpieces to be machined on machine tools. In this case, a partial area of the workpiece to be machined is arranged in the collet chuck and fixed in space by the collet chuck, so that the portions of the object protruding into the space are freely accessible and can therefore be machined by tools of the machine tool. The outer contours of the objects to be clamped determine the inner contours of the collet chuck, because the collet chuck is compressed when it is drawn into the chuck body due to the contact surface running into the jacket surface of the receiving opening and the horizontally tapering contact surface. Usually, the collet chuck consists of a plurality of segments, which, for example, are given a corresponding shape in a vulcanization process, and the spaces between the segments of the collet chuck, which are made of metal or spring steel, are connected with plastic or rubber material via the vulcanization. Consequently, the collet chuck has a certain elasticity in radial direction.

The chuck body has a receiving opening, the inner contours of which must be adapted to the outer contour of the collet chuck. On the one hand, this means that the inner contour of the receiving opening must be designed to be inclined inwards to ensure that the collet chuck is compressed in the radial direction, i.e. in the direction of the object to be clamped, when it is drawn into the receiving opening, thus reducing the inner diameter of the collet chuck. On the other hand, the collet chuck must be aligned centred in the receiving opening in relation to its longitudinal axis, which serves as a reference value. The longitudinal axis of the collet chuck and the longitudinal axis of the receiving opening should therefore be coaxial. Due to the axially movable pulling element in the chuck body, which is driveably coupled with the collet chuck, a correspondingly large pulling force can be exerted on the collet chuck, causing it to be pulled into the interior of the receiving opening. Due to the existing inclinations on the inner wall of the receiving opening, radial force components are created by which the segments of the collet chuck connected to one another by vulcanization are compressed and consequently exert a clamping force on the object inserted into the collet chuck.

It has turned out to be a disadvantage that each collet chuck must first be adapted to the outer contour of the object to be clamped, as a result of which the outer dimensions of the collet chuck are inevitably predetermined at least within a certain limit range. If the outer diameter of the object to be clamped is considerably larger than the previous outer diameter of other objects, then the respective collet chuck can be manufactured and used as a special design, however, it is often not possible to use the collet chuck enlarged in this way in a chuck body with a specific receiving opening. Accordingly, differently sized receiving openings must be provided in the chuck body to compensate for the differences in size of the collet chuck. However, this means that time-consuming and therefore cost-intensive retooling measures have to be carried out on the machine tools if the external geometry in the objects to be machined changes significantly.

### SUMMARY OF THE INVENTION

It is therefore the task of the present invention to further develop a clamping device of the aforementioned type in such a way that a large number of objects of different sizes can be inserted into a receiving opening of a chuck body, and can be locked in a centred position in this opening without the chuck bodies or their receiving openings having to be adapted to the differently sized collet chucks.

This task is solved by the features of the characterising part of Patent Claim 1.

Further advantageous embodiments of the present invention are derived from the subordinate claims.

In that an adapter sleeve is provided which is arranged between the receiving opening of the chuck body and the collet chuck in a positionally oriented arrangement and centred on the conical centring surface, in that the outer contour of the adapter sleeve is adapted to the inner contour of the receiving opening, in that the collet chuck is mounted in the adapter sleeve so as to be axially movable, and in that the inner contour of the adapter sleeve has an inwardly inclined contact surface which interacts with the outer contour of the collet chuck in such a way that the internal diameter of the collet chuck is reduced when the collet chuck is drawn into the chuck body by the pulling element and the object is thus held centred and in a positionally oriented manner, a large number of objects of different sizes can be inserted into an identical receiving opening in the chuck body with correspondingly adapted collet chucks and can be fixed there in a centred manner, since the adapter sleeve arranged in between performs a spatial compensation. Consequently, corresponding large adapter sleeves must be adapted to the outer geometry of the collet chuck and these can be replaced quickly and easily. The respective collet chuck, together with a correspondingly adapted adapter sleeve, thus forms a kind of modular system which compensates for both the external geometry of the objects to be machined and the internal geometry of the receiving opening of a chuck body. As a result, there is no need for conversion measures when exchanging chuck bodies with correspondingly differently designed receiving openings.

As the adapter sleeve is a separate component, it can be adapted to the existing inner contours of the receiving opening in the variously designed chuck body in an advantageous way and at the same time receive the respective collet chuck and fix it in a centred arrangement. Consequently, no conversion measures need to be carried out on the chuck body, as it is only necessary to use adapter sleeves of different design for the respective application or the prevailing structural geometries of the objects to be clamped and thus of the collet chucks.

In addition, modular systems can be provided by the manufacturer and the respective pairs of adapter sleeves and collet chucks can be offered for different objects to be clamped. This enables an extremely individual design, which is adapted to the respective application and the manufacturing costs of which are extremely low.

The slots incorporated in the adapter sleeve, which run parallel to the longitudinal axis of the receiving opening in the mounted condition, are formed on a retaining ring and protrude from it, thus enabling the collet chuck to move so as to fix the object to be held. The slots namely cause individual segments to protrude from the retaining ring, which act on the workpiece to be clamped in the manner of a pair of gripping pliers with a plurality of fingers. This is because the collet chuck is pressed against the inclined contact surface of the adapter sleeve as soon as the collet chuck is drawn into the receiving opening of the chuck body by the pulling element. As the inner diameter of the adapter sleeve is reduced, the segments or fingers of the collet chuck are pressed in the direction of the longitudinal axis of the receiving opening and first come into effective contact with the object to be clamped, and as the collet chuck is further drawn into the receiving opening, a clamping force is generated in the radial direction, by means of which the object is locked in the collet chuck.

In addition, the retaining ring can be advantageously equipped, for example, with a bayonet lock consisting of three or more bayonet openings, in order to couple the retaining ring with the pulling element. The retaining ring is therefore only to be placed on the counterparts of the bayonet lock which are assigned to the pulling element and, by twisting it, an undercut is created by means of which the axial pulling forces are supported and transferred from the pulling element to the collet chuck. In order to secure the collet chuck on the pulling element against rotation, a screw is provided to hold the collet chuck in the correct position.

If the slots have different widths in the direction of the longitudinal axis, this on the one hand increases the possibility of movement of the separated segments or fingers of the collet chuck and on the other hand the contact surface between the free ends of the segments or fingers of the collet chuck and the object to be clamped can be increased. The slots can be V-shaped in the direction of the longitudinal axis; the orientation of the V-shaped slots depends on the desired rigidity or bending elasticity of the collet chuck.

In order to limit the penetration of the collet chuck into the chuck opening, a contact surface is provided either on the outside end face of the adapter sleeve or inside the chuck body, by which the adjustment travel of the collet chuck is limited.

As soon as the clamping condition is achieved, it should be easily and reliably possible to check the alignment of the collet chuck with respect to the longitudinal axis of the receiving opening. This is achieved by providing an air transfer adapter between the adapter sleeve and the collet chuck, in which one or more air ducts are incorporated. The input side of the air ducts is connected to a pressure pump and to an evaluation device, and the outputs of the air ducts are assigned to the contact surface of the adapter sleeve or the stop ring inside the receiving opening. As soon as the collet chuck rests on the contact surface or the stop ring, the pressure pump creates a pressurised condition by forcing ambient air into the channel. If one of the outlet sides of the air ducts is not covered by the collet chuck, the ambient air escapes and the pressurised condition reaches a low pressure level. This can be determined by the evaluation device, so that with the help of the set pressure it can be checked without further ado whether the collet chuck is in full contact with the stop face of the adapter sleeve or the stop ring inside the receiving opening, i.e. over the entire circumference.

### BRIEF DESCRIPTION OF THE DRAWINGS

The drawings shows a sample embodiment of a clamping device configured in accordance with the present invention, the details of which are explained below. In the drawings:

FIG. 1a shows a clamping device consisting of a chuck body in which a receiving opening is incorporated, a pulling element axially movable in the receiving opening, an adapter sleeve inserted in the receiving opening and a collet chuck penetrating the adapter sleeve, by which an object is held positionally oriented and centred, in a sectional view and in the initial condition,

FIG. 1b shows the device according to FIG. 1a, in an exploded view,

FIG. 2a shows a further embodiment of the clamping device according to FIG. 1a, with an air transfer adapter located between the adapter sleeve and the collet chuck, in which three air ducts are incorporated to check the correct clamping condition of the collet chuck,

FIG. 2b shows the clamping device according to FIG. 2a, which has a stop provided in the chuck body, in an exploded view,

FIG. 2c shows the clamping device according to FIG. 2a, with a pressure pump and an evaluation device to check the clamping condition, and in the clamping condition,

FIGS. 3a to 3c show the clamping device according to FIG. 1b, with differently configured objects and a collet chuck adapted to them.

### DETAILED DESCRIPTION OF THE PREFERRED EMBODIMENTS

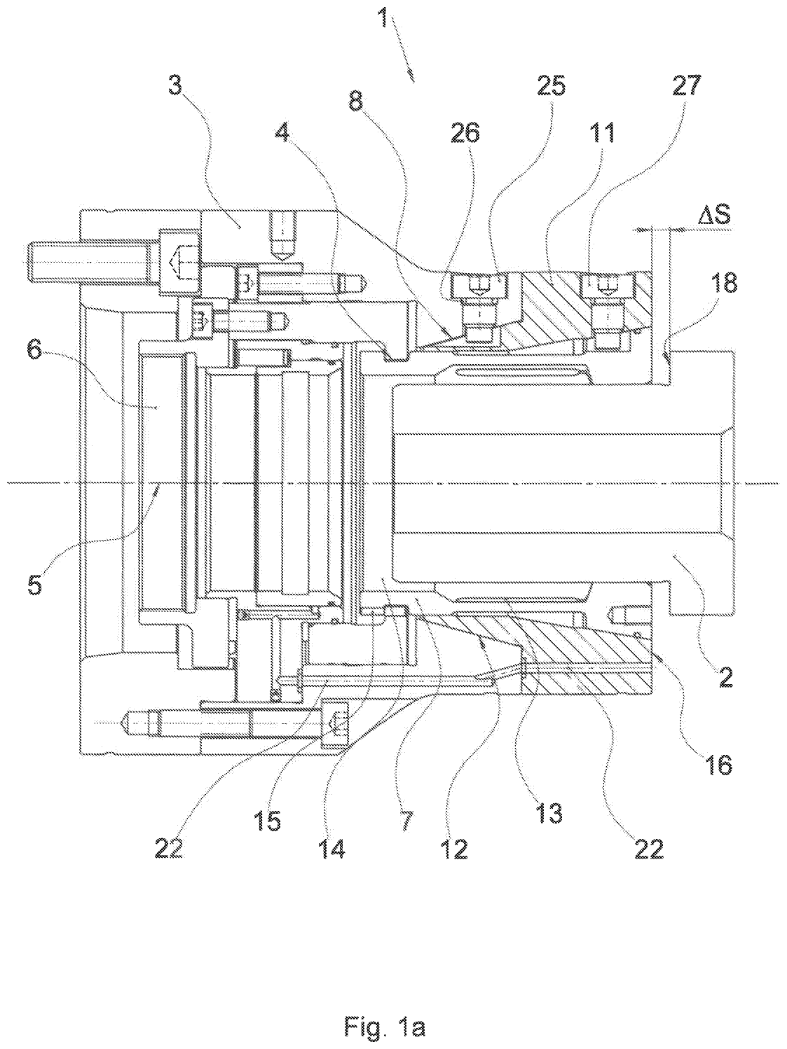

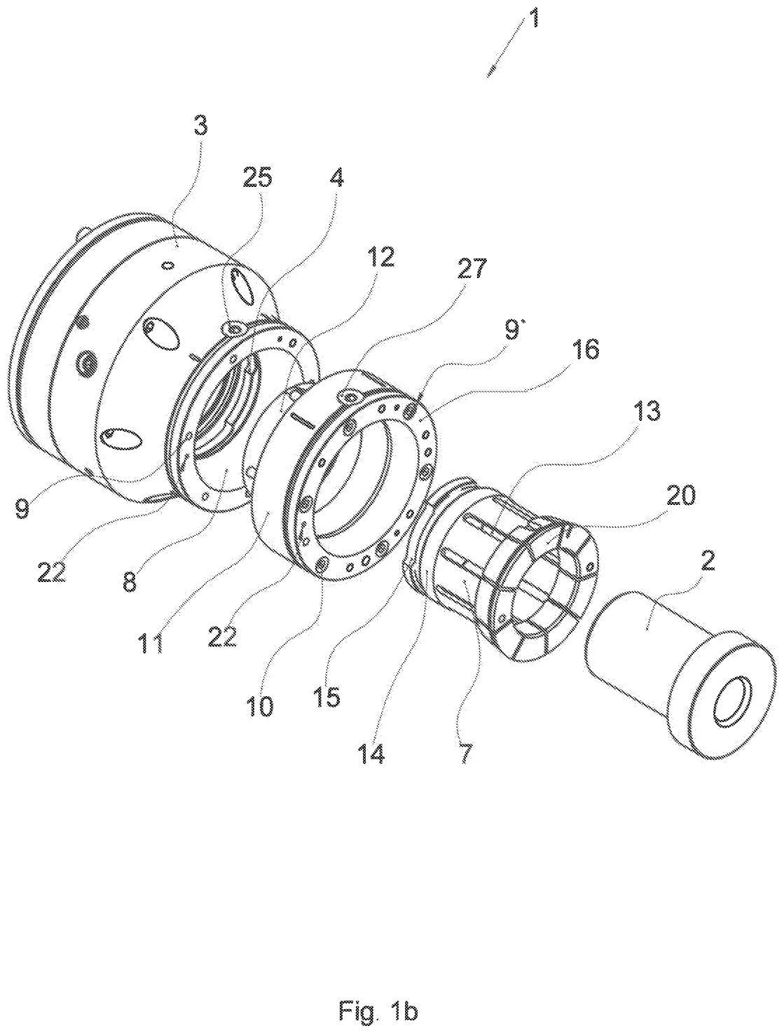

FIGS. 1a and 1b show a clamping device 1 by means of which an object 2 is to be centred and supported with repeat accuracy. The object 2 can be designed as a workpiece to be machined on a machine tool, as a tool or the like. The outer contour of the object 2 to be clamped can be arbitrary.

The clamping device 1 essentially consists of a chuck body 3, in which a receiving opening 4 is incorporated. The longitudinal axis of the receiving opening 4 is provided with the reference number 5 and serves as a reference for the alignment of the object 2 to be supported on the chuck body 3. The axis of rotation or symmetry of the respective object 2 should therefore be aligned coaxially with the longitudinal axis 5 in the clamping condition, so that the object 2 is supported in a defined position on the chuck body 3. Since a large number of identical objects 2 often have to be supported on the chuck body 3 for their machining, it is necessary that when the identical objects 2 are exchanged, they are fixed in a repeatable manner in relation to the longitudinal axis 5 of the receiving opening 4.

Inside the chuck body 3, a pulling element 6 is provided which is designed as a pneumatic or hydraulic piston, for example. The pulling element 6 can also be driven by an electric motor. The pulling element 6 is mounted in an axially movable arrangement in the receiving opening 4 of the chuck body 3, and therefore moves from a starting position to a clamping position, as explained in detail below.

A collet chuck 7 is used to fix the object to be machined 2 on the chuck body 3, which is operatively connected to the respective pulling element 6. The inner contours of the collet chuck 7 are adapted to the outer contour of the object 2 to be clamped, so that the respective object 2 can be inserted into the interior of the collet chuck 7.

A conically configured centring surface 8 is machined into the entrance area of the receiving opening 4. The centring surface 8 is thus inclined from the outside inwards, i.e. in the direction of the longitudinal axis 5, and is intended to align an adapter sleeve 11, which is to be inserted or inserted into the locating opening 4, in relation to the longitudinal axis 5 and support it on the chuck body 3.

The outer contour of the respective adapter sleeve 11 is adapted to the inner contours of the receiving opening 4. In addition, after insertion, the adapter sleeve 11 is fixed in a non-rotatable arrangement on the chuck body 3 by means of a fixing screw 25 screwed into a threaded hole 26 worked in the chuck body 3. As a result, the adapter sleeve 11 cannot move about its own axis or in the longitudinal direction after insertion.

Inside the adapter sleeve 11, there is a tapered contact surface 12 which interacts with the outer contour of the collet chuck 7 in the clamping condition. The outer contour of the collet chuck 7 is therefore in contact with the contact surface 12 of the adapter sleeve 11 in the inserted condition or in the clamping condition.

Several slots 13 are worked into the outer surface of the collet chuck 7, which run parallel to the longitudinal axis 5 of the receiving opening 4 in the assembled condition. The slots 11 have different widths over their length. Due to the incorporated slots 13, segments or gripper fingers 20 are created in the collet chuck 7, which act on the object to be clamped 2. In addition, the collet chuck 7 consists of a retaining ring 14, on which the respective segments or gripper fingers 20 are formed and from which they protrude. The retaining ring 14 preferably has three bayonet locks 15 which are provided in corresponding openings in the pulling element 6 for the drive coupling of the collet chuck 7 with the pulling element 6. The bayonet locks 15 of the retaining ring 14 are therefore inserted into the corresponding locating holes of the pulling element 6 during the assembly process and pushed into them by twisting, for example by 20° to 30°. Consequently, a kind of undercut is created between the bayonet locks 15 of the retaining ring 14 and the corresponding receptacles provided on the pulling element 6, through which the axially acting forces of the pulling element 6 are transmitted to the collet chuck 7. In order to prevent the retaining ring 14 from being unintentionally or unwantedly unscrewed from the receiving openings of the pulling element 6, a screw 27 is provided which is inserted through the adapter sleeve 11 and acts by means of friction on the outside of the collet chuck 7 so that it is secured against turning.

If the collet chuck 7 is now inserted into the adapter sleeve 11 and the driving connection between the collet chuck 7 and the pulling element 6 is established, the collet chuck 7 can be pulled into the interior of the receiving opening 4 by moving the pulling element 6 back from its initial position to the clamping position. The respective object 2 is located inside the collet chuck 7. Since the adapter sleeve 11 has a conical contact surface 12 which is inclined from the outside inwards, the segments or gripper fingers 20 formed by the contactors 13 are pressed together in the direction of the longitudinal axis 5. This reduces the inside diameter of the collet chuck 7, which creates a radial clamping force that acts directly on the surface of the object 2 to be clamped. Due to this radial clamping force, the respective object 2 is held in the collet chuck 7 in a positionally oriented manner, since the segments 20 are synchronously advanced in the direction of the object 2 due to the uniformly running conical contact surface 12 of the adapter sleeve 11, so that a centred positioning of the object 2 on the collet chuck 7 is achieved.

The adapter sleeve 11 is first inserted into the receiving opening 4 of the chuck body 3. Threaded holes 9 are provided on the outside end face of the chuck body 3 and corresponding through-holes 9′ are provided on the outside end face of the adapter sleeve 11. The threaded holes 9 and the through-hole 9′ must be positioned flush with one another, and then the adapter sleeve 11 can be attached to the chuck body 3 by means of threaded screws.

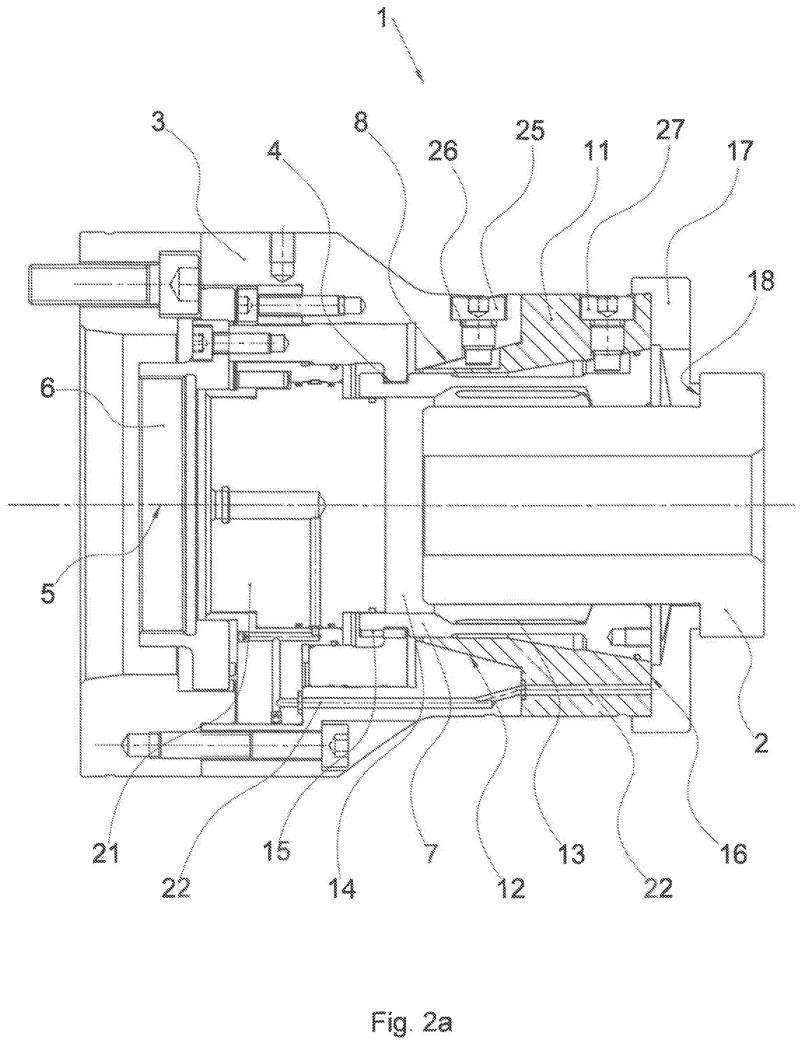

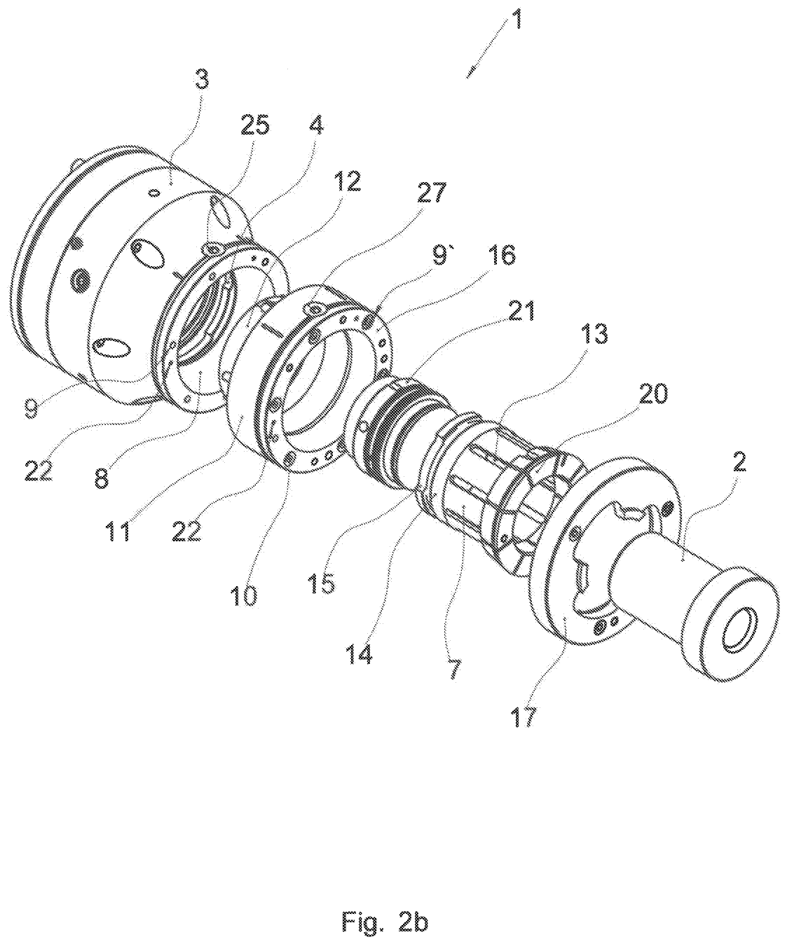

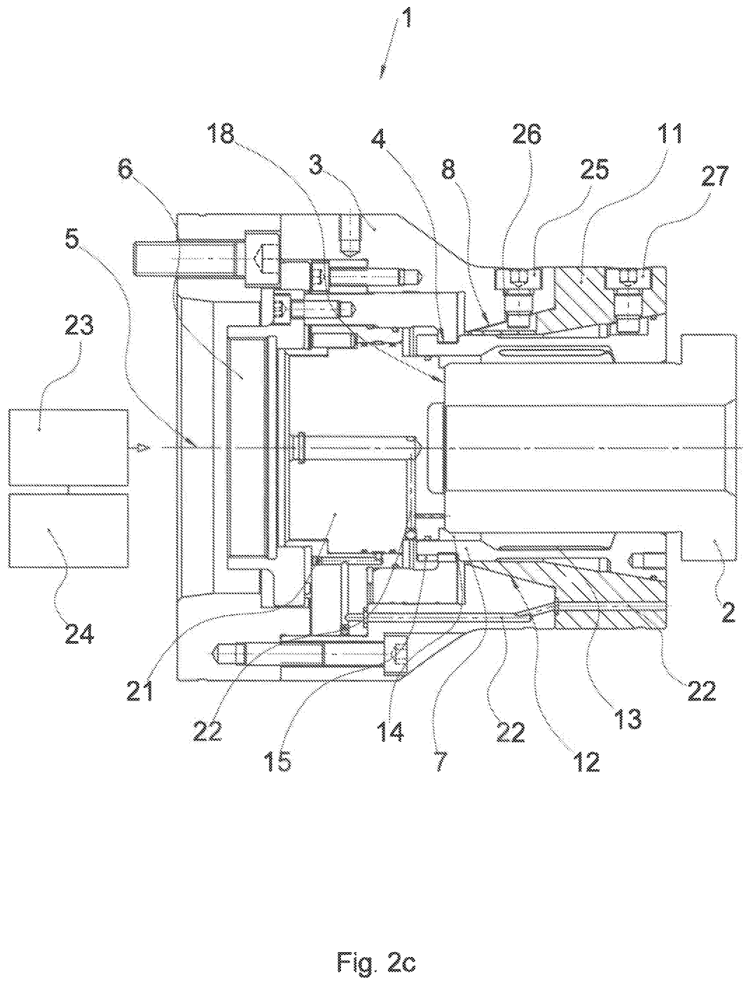

FIGS. 2a, 2b and 2c show a further embodiment of the clamping device 1 according to the present invention. In addition, an air transfer adapter 21 is positioned between the adapter sleeve 11 and the collet chuck 7. Three air ducts 22 are incorporated in the air transfer adapters 21, which form a common compressed air system with the air ducts 22 provided in the chuck body 3. The input sides of the air ducts 22 are connected to a pressure pump 23 and an evaluation unit 24.

In addition, either a stop ring 17 is provided on the collet chuck 7 or a ring-shaped contact surface 18 is provided inside the receiving opening 4. As soon as the collet chuck 7 is pulled into the interior of the chuck body 3 by the pulling element 6, the stop ring 17 or the collet chuck 7 reaches the ring-shaped contact surface 18. On the one hand, this mechanically limits the adjustment travel Δs of the collet chuck 7 and, on the other hand, the contact positioning thus produced between the collet chuck 7 and the outside of the adapter sleeve 11 or the retaining ring 14 of the collet chuck 7 can be checked for the desired exact positioning on the inside annular contact surface 18 with the aid of the air transfer adapter 21. This is due to the fact that a positive pressure is created in the air ducts 22 of the air transfer adapter 21 due to the pressure pump 23 which forces in the ambient air. If the stop ring 17 is flush with the adapter sleeve 11 or if the collet chuck 7 is flush with the ring-shaped contact surface 18, then the positive pressure in the air duct 22 should be constant, as its outlets are sealed airtight. The air ducts 22 open out on the outside of the adapter sleeve 11 and the excess air pressure generated acts directly on the stop ring 17 or the air ducts 22 open out in the area of the ring-shaped contact surface 18, and are therefore closed by the retaining ring 14 of the collet chuck 7. If an air gap is created between the collet chuck 7 and the stop ring 17 or the retaining ring 14 of the collet chuck 7 and the ring-shaped contact surface 18 due to an inclined or tilted positioning of the collet chuck 7, the ambient air forced into the air duct 22 escapes and the air pressure falls below a specified limit value. This can be detected by the evaluation device 24 assigned to the air ducts 22, so that a corresponding check is carried out by this device and, for example, the machine tool is stopped if an incorrect positioning of the collet chuck 7 is detected.

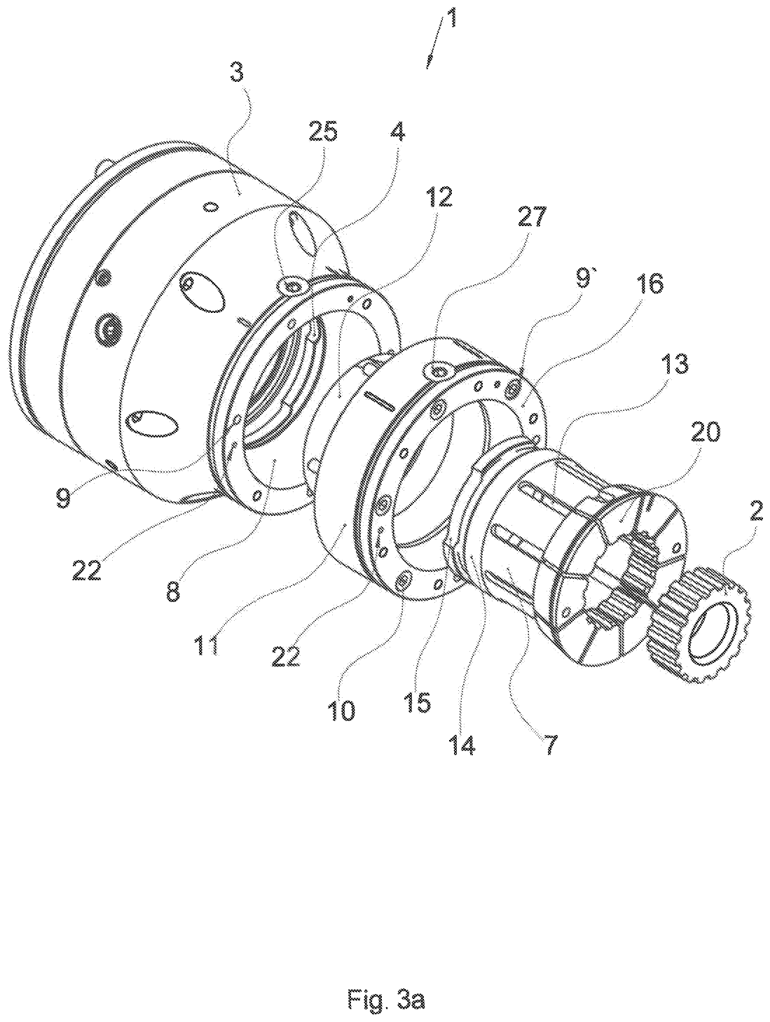

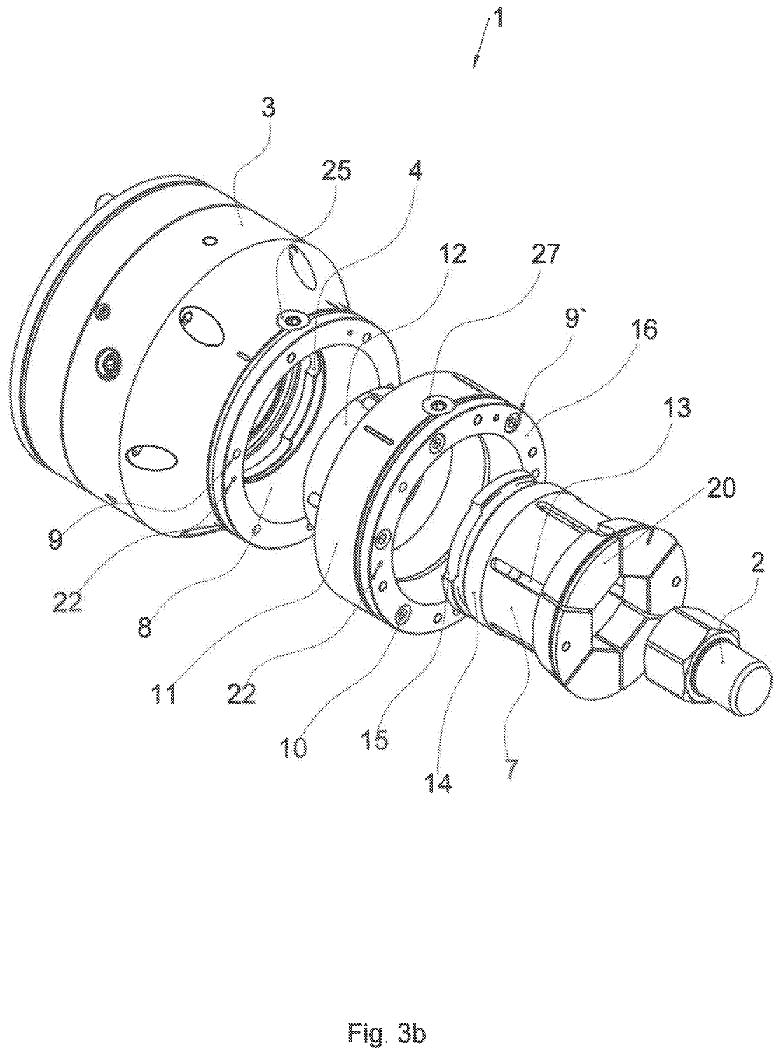

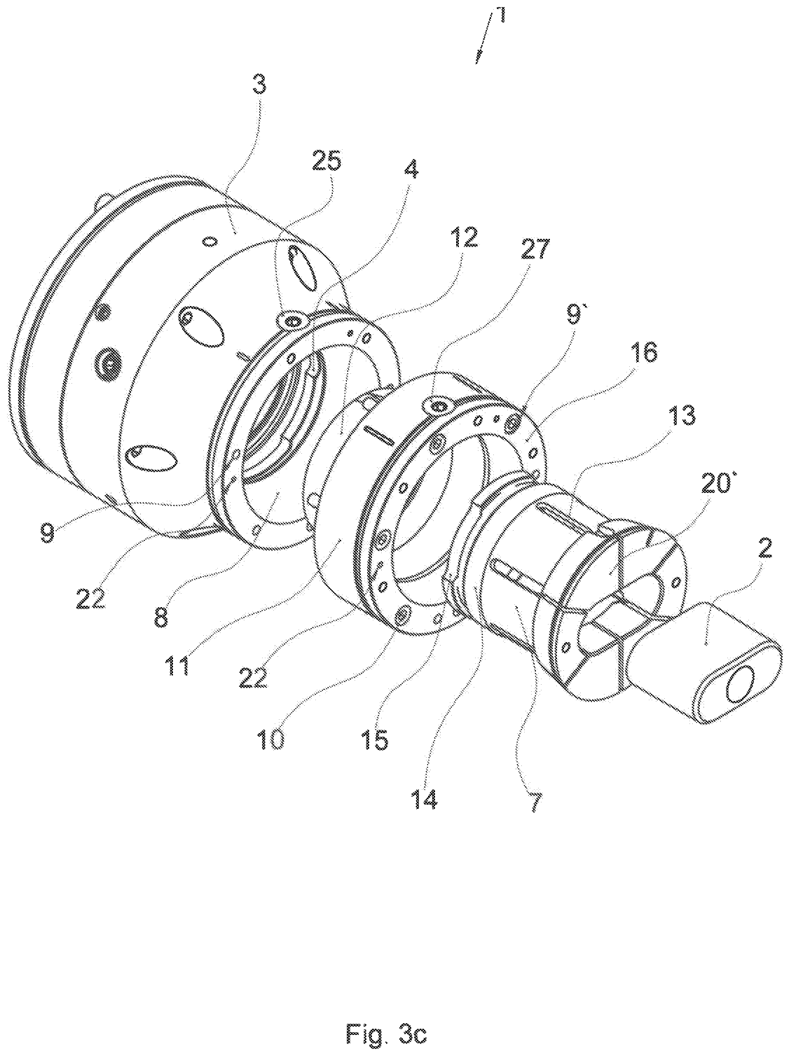

FIG. 3a shows that the collet chuck 7 also holds an object 2 in the form of a gear wheel with external teeth. The gear wheel 2 configured in this way is to be held in the outside area of the collet chuck 7 by the latter in the manner described above. For this purpose, the inner contour of the collet chuck 7 has internal teeth which correspond to the external teeth of the object 2. Thus, the segments 20 act on the external teeth of the object 2.

FIG. 3b shows that a cubic object 2 is also held in the collet chuck 7. The polygonal outer contour of the object 2 is correspondingly reproduced inside the collet chuck 7, so that certain areas of the object 2 are inserted in the interior of the collet chuck 7 and the object 2 is supported by the surfaces of the collet chuck 7 which are suitably shaped.

FIG. 3c shows another variant of the geometry of an object 2 to be clamped, which has an elliptical base in this case. The collet chuck 7 therefore reproduces the outer contour of the elliptical object 2, which again results in a positionally oriented and centred fixing of the object 2.

The object 2 to be held therefore defines the inner contour of the collet chuck 7. The receiving opening 4 incorporated in the chuck body 3 cannot normally be changed, so that the respective adapter sleeve 11 bridges the gap between the inner wall of the receiving opening 4 and the collet chuck 7. In addition, the inner contour of the adapter sleeve 11 can be adapted to the outer contour of the collet chuck 7 in the manner of a modular system. The collet chuck 7 and the respective adapter sleeve 11 thus form a mounting pair. The adapter sleeve 11 is therefore used to compensate for the gap between the receiving opening 4 and the collet chuck 7, and the adapter sleeve 11 compensates for the outer contour of the collet chuck 7 used in relation to the receiving opening 4 of the chuck body 3.

What is claimed is:

1. A clamping device (1) for the centred and repetitively accurate support of an object (2), in particular a workpiece to be machined on a machine tool, a tool or the like, the clamping device comprising:
a chuck body (3) in which a receiving opening (4) is incorporated which has a longitudinal axis (5) as a centring reference for the object (2),
a pulling element (6) which is mounted axially movably in the receiving opening (4),
a collet chuck (7) which is inserted into the receiving opening (4) centred on the longitudinal axis (5) of the receiving opening (4) and which is driveably coupled to the pulling element (6), and
a conical centring surface (8) which is worked onto the inner wall in the entrance area of the receiving opening (4),
characterized in that,
an adapter sleeve (11) is provided, which is arranged between the receiving opening (4) of the chuck body (3) and the collet chuck (7) in the assembled condition, positionally oriented and centred on the conical centring surface (8),
the outer contour of the adapter sleeve (11) is adapted to the inner contour of the receiving opening (4),
the collet chuck (7) is mounted in the adapter sleeve (11) so as to be axially movable,
and in that the inner contour of the adapter sleeve (11) has an inwardly inclined contact surface (12) which interacts with the outer contour of the collet chuck (7) in such a way that the inner diameter of the collet chuck (7) is reduced when the collet chuck (7) is drawn into the chuck body (3) by the pulling element (6) and the object (2) is thereby held centred and positionally oriented by the collet chuck (7).

2. The clamping device according to claim 1,
characterized in that,
a plurality of slots (13) are incorporated in the adapter sleeve (11), these slots (13) running parallel to the longitudinal axis (5) of the receiving opening (4) in the assembled condition, that the adapter sleeve (11) has a retaining ring (14) which is coupled to the pulling element (6) and by means of which the individual segments of the adapter sleeve which run adjacent to the slots (13) are held.

3. The clamping device according to claim 2,
characterized in that,
the retaining ring (14) of the adapter sleeve (11) is inserted into the pulling element (6) by means of a plurality of bayonet locks (15) spaced apart from one another and is secured on the pulling element (6) by rotation.

4. The clamping device according to claim 2,
characterized in that,
the slots (13) are dimensioned with different widths along their length.

5. The clamping device according to claim 1,
characterized in that,
a stop ring (17) is integrally formed on the outside end face (16) of the adapter sleeve (11), which stop ring (17) bears against the collet chuck (7) when it is drawn into the receiving opening (4) and limits the adjustment travel (As) of the collet chuck (7),
or in that an annular contact surface (18) is provided in the interior of the chuck body (3), against which the collet chuck (7) rests when it is drawn in and the adjustment path (Δs) of the collet chuck (7) is limited.

6. The clamping device according to claim 5,
characterized in that,
an air transfer adapter (21) is provided between the adapter sleeve (11) and the collet chuck (7), into which air transfer adapter (21) a plurality of air ducts (22) are incorporated, and in that a compressed air pump (23) assigned to the inputs of the air ducts and an evaluation device (24) are provided and the output side of the air ducts (22) faces the bearing ring (17) or the contact surface (18), and in that the pressure conditions during the clamping operation are set by the compressed air pump (23) and monitored by the evaluation device (24).

7. The clamping device according to claim 1,
characterized in that,
the adapter sleeve (11) is secured against rotation by means of a screw (25) which is screwed into a threaded hole (26) made in the chuck body (3).

8. The clamping device according to claim 1,
characterized in that,
the collet chuck (7) is secured against rotation by means of a screw (27) on the pulling element (6).
